(19) United States
(12) Patent Application Publication
(10) Pub. No.: US 2016/0171123 A1
(43) Pub. Date: Jun. 16, 2016

(54) Apparatus, recording medium, terminal and computer program for searching data pattern

(71) Applicant: INFORIENCE INC., Daejeon (KR)

(72) Inventor: Jin Hyuk Choi, Daejeon (KR)

(21) Appl. No.: 14/696,374

(22) Filed: Apr. 25, 2015

(30) Foreign Application Priority Data
Dec. 11, 2014 (KR) 10-2014-0178099

(51) Int. Cl. G06F 17/30

(52) U.S. Cl. CPC G06F 17/30991; G06F 17/30958

(57) ABSTRACT

Provided is a computer program recorded in a medium. The program is configured to execute functions of: displaying a horizontal axis and a vertical axis which intersect each other perpendicularly through a display unit; displaying a point or a line according to operation of an input unit through the display unit in a state in which the horizontal axis and the vertical axis are displayed; and displaying a part corresponding to a query according to the point or the line among time series data through the display unit.

### CROSS-REFERENCE TO RELATED APPLICATION

This application claims priority under 35 U.S.C. §119 from Korean Application No. 10-2014-0178099 filed on Dec. 11, 2014, the subject matter of which is incorporated herein by reference.

### BACKGROUND OF THE DISCLOSURE

1. Field of the Disclosure

The present invention relates to an apparatus, a recording medium, a terminal, and a computer program for searching a data pattern.

2. Description of the Related Art

Generally, a search engine means a system that searches a document that contains a specific word or sentence. When using the search engine, user inputs a word or a phrase that represents the content that the user desires to search into a query window of the search engine, and receives a result extracted by the search engine.

Recently, a data type utilized by user may be a numeric type or, furthermore, a time series form as well as a document. For example, recently, financial data such as a stock, a card usage, sensor data provided by internet-of-things based sensors, biological signal data provided by wearable sensors attached to body, and the like have been increasingly used by individual users.

In most cases, these data are formed of a series of numerical value, that is, a time series form. Thus, it is important to search and discover a meaningful pattern contained in time-series in order to fully utilize time series data.

However, currently, the task of searching the pattern contained in the time series is limited to the work of some experts. The experts applies the task by implementing various types of filter by means of computer programming, or perform an analysis of time series data by utilizing a frequency domain based technology. However, since these technologies require a high level technical knowledge, the utilization of these technologies by general users who are not the expert has limits.

For this reason, the general users who did not receive a technical education are not able to search or utilize directly the pattern included in the time series data by utilizing their experience or knowledge.

### SUMMARY

The present invention has been made in view of the above problems, and provides an apparatus, a recording medium, a terminal, and a computer program for searching a data pattern such that a general user as well as an expert may be able to search a pattern of time series data.

In accordance with an aspect of the present invention, a computer program is configured to execute functions of: displaying a horizontal axis and a vertical axis which intersect each other perpendicularly through a display unit; displaying a point or a line according to operation of an input unit through the display unit in a state in which the horizontal axis and the vertical axis are displayed; and displaying a part corresponding to a query according to the point or the line among time series data through the display unit.

The time series data, which are displayed through the display unit, comprise a plurality of straight lines, and the part corresponding to the query is a point located in the plurality of straight lines or some of the plurality of straight lines.

The computer program is configured to further execute functions of: generating a coordinate of the point or a coordinate of an end point of the line when a point of intersection of the horizontal axis and the vertical axis is defined as origin; and automatically generating a parameter of the query through at least one of the coordinate of the point and the coordinate of the end point of the line.

The computer program is configured to further execute a function of displaying another portion of the time series data which is delayed according to time delay information from a portion corresponding to a query and which corresponds to an additional query through the display unit, according to an input of the time delay information and the additional query through the input unit.

The computer program is configured to further execute a function of displaying a portion of additional time series data which is delayed according to time delay information from a portion of the time series data corresponding to the query and which corresponds to an additional query through the display unit, according to an input of the time delay information and the additional query through the input unit.

The query is one of n (n is a natural number greater than 2) basic queries, and the additional query is one of the n (n is a natural number greater than 2) basic queries.

The computer program is configured to further execute functions of: changing a curve query pattern displayed on the display unit into a segment according to an operation of the input unit; and displaying a portion of the time series data corresponding to a query of each of the segment through the display unit.

The computer program is configured to further execute a function of automatically generating a query corresponding to a part of the time series data specified according to operation of the input unit.

The computer program is configured to further execute functions of: displaying a guide line to represent each segment of the time series data; and matching the segment to the query.

In accordance with another aspect of the present invention, a terminal includes: a display unit; a central processing unit (CPU) configured to execute a set of instructions contained in a data pattern search program stored in a memory; and an input unit configured to output an operation signal according to user's handling, wherein the data pattern search program performs functions of: displaying a horizontal axis and a vertical axis which intersect each other perpendicularly through the display unit; displaying a point or a line according to operation of the input unit through the display unit in a state in which the horizontal axis and the vertical axis are displayed; and displaying a part corresponding to a query according to the point or the line among time series data through the display unit.

In accordance with another aspect of the present invention, a data pattern search apparatus includes: a data conversion unit configured to perform segmentation for time series data to generate segment time series data; and a data extraction unit configured to extract part of the segment time series data corresponding to a query inputted through an input unit, wherein the query is generated according to a point or a line according to operation of the input unit.

### BRIEF DESCRIPTION OF THE DRAWINGS

The objects, features and advantages of the present invention will be more apparent from the following detailed description in conjunction with the accompanying drawings, in which:

FIG. 1 illustrates a data pattern search system according to an exemplary embodiment of the present invention;

FIG. 2 is an example of a terminal according to an exemplary embodiment of the present invention;

FIG. 3 illustrates time series data and segment time series data;

FIG. 4 is an operation example of a data pattern search apparatus according to an exemplary embodiment of the present invention;

FIG. 5 is an example of an execution process of a data pattern search program according to an exemplary embodiment of the present invention;

FIGS. 6 to 9 are an example of a query which is generated by a data pattern search program according to an exemplary embodiment of the present invention;

FIGS. 10 to 12 are another example of a query which is generated by a data pattern search program according to an exemplary embodiment of the present invention; and

FIGS. 13 and 14 show an operation example of a data pattern search program according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Prior to a detailed description of the present invention, terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the embodiments and the configurations depicted in the drawings are illustrative purposes only and do not represent all technical scopes of the embodiments, so it should be understood that various equivalents and modifications may exist at the time of filing this application. Some constituent elements shown in the drawings may be exaggerated, omitted or schematically drawn for the purpose of convenience or clarity.

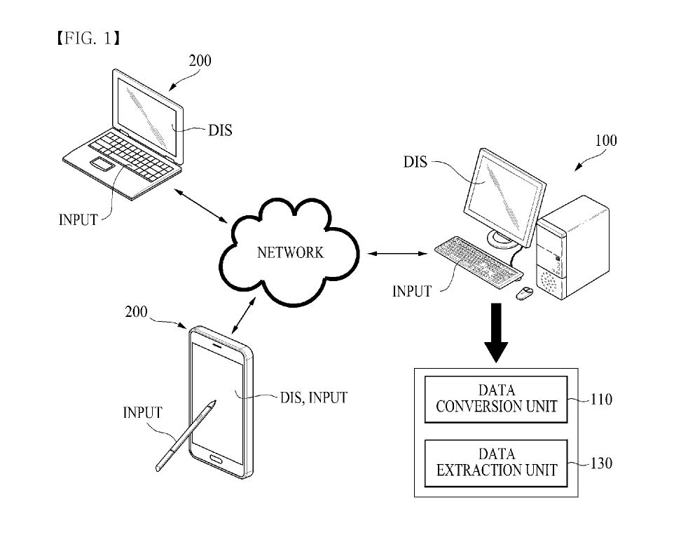

FIG. 1 illustrates a data pattern search system according to an exemplary embodiment of the present invention. As shown in FIG. 1, the data pattern search system according to an exemplary embodiment of the present invention may include a data pattern search apparatus 100 and a terminal 200.

The data pattern search apparatus 100 and the terminal 200 may perform a server/client communication through a network, and may include at least one of hardware and software for the server/client communication. Since the server/client communication is well known to a person skilled in the art, a detailed description is omitted.

The data pattern search apparatus 100 may store a data pattern search program which will be described later, and may transmit the data pattern search program to the terminal 200 at the request of the terminal 200. The terminal 200 may install the transmitted data pattern search program, and may execute the data pattern search program after installing the data pattern search program.

The data pattern search apparatus 100 may search a part desired by user among time series data. The time series data will be described later in detail with reference to the accompanying drawings.

The terminal 200 may perform communication with the data pattern search apparatus 100, and may process a graphic user interface for query input.

In this case, the data pattern search apparatus 100 may also process the graphic user interface for query input.

The terminal 200 may include a hand-held computer, a tablet computer, a mobile phone, a smart phone, a media player, PDA, a personal computer, a laptop computer, and a combination of two or more of those items which are capable of communicating with the data pattern search apparatus 100, but is not limited thereto.

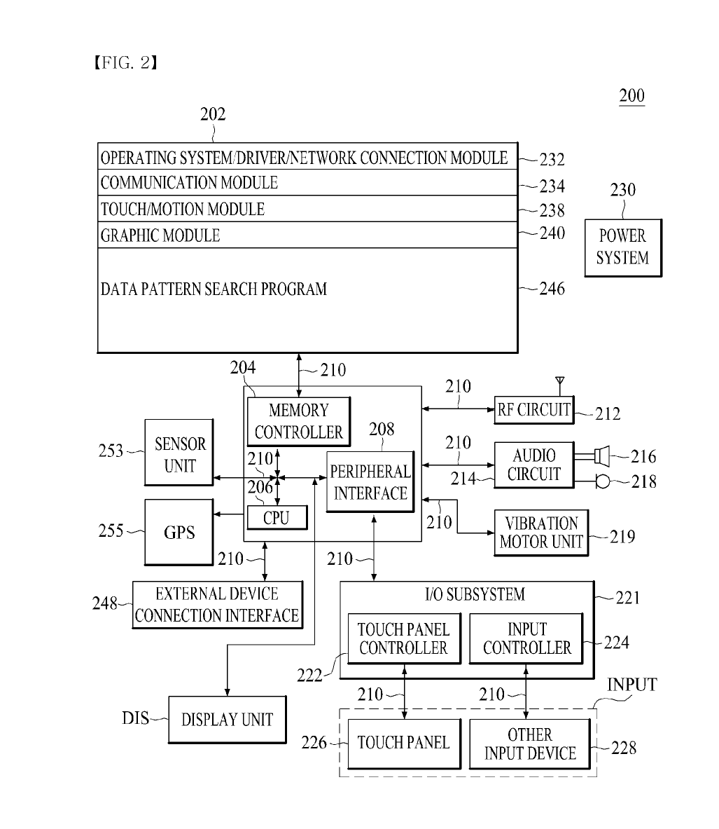

FIG. 2 is an example of a terminal according to an exemplary embodiment of the present invention. As shown in FIG. 2, the terminal 200 may include a memory 202, a memory controller 204, one or more CPU 206, a peripheral interface 208, a radio frequency (RF) circuit 212, an audio circuit 214, a speaker 216, a microphone 218, a vibration motor unit 219, a I/O subsystem 221, a touch panel 226, or other input device 228, an external device connection interface 248, a sensor unit 253, and a GPS unit 255. These elements may perform a communication through one or more communication buses or a signal line 210.

The terminal 200 of FIG. 2 is an example of a portable electronic device, and the configuration of the terminal 200 may have more elements or less elements than elements shown in the drawing, or may have different elements. Accordingly, the terminal 200 is not limited to the portable electronic device.

Various elements shown in FIG. 2 may process one or more signals and/or include application specific integrated circuit, and may be implemented by hardware, software, or a combination of hardware and software.

The memory 202 may store various programs necessary for the operation of the terminal 200 and a computer program according to an exemplary embodiment of the present invention. The memory 202 may be implemented in various forms. For example, the memory 202 may include RAM, ROM, flash memory, and an optical disk such as CD or DVD or Blu-ray disc, but is not limited thereto.

In addition, FIG. 2 shows that the memory 202 is provided in the terminal 200, but it is not limited thereto, and the terminal 200 may be connected to the memory 202 through communication as the memory 202 is provided to an external of the terminal 200.

Hereinafter, the computer program according to an exemplary embodiment of the present invention is referred to as a data pattern search program. The data pattern search program will be described later in detail with reference to drawings.

The memory controller 204 may control access to the memory 202 by the element of the terminal 200 such as CPU 206 and peripheral interface 208.

The peripheral interface 208 may connect an input and output peripheral device of the terminal 200 with the CPU 206 and the memory 202.

The CPU 206 may execute various software programs including the data pattern search program and/or a set of instructions that are stored in the memory 202, and may perform various functions for the terminal 200 and process the data.

The radio frequency (RF) circuit 212 may transmit and receive an electromagnetic wave. The RF circuit 212 may convert an electrical signal into an electromagnetic wave and vice versa, and communicate with a communications network and other communications device through the electromagnetic wave.

The audio circuit 214, the speaker 216 and the microphone 218 may provide an audio interface between a user and the terminal 200. The audio circuit 214 and the speaker 216 may be used to perform a function such as an audible alert or warning.

The I/O subsystem 221 may provide an interface between the peripheral interface 208 and an input unit (INPUT) of the terminal 200 such as the touch panel 226 and other input device 228. At this time, the other input device 228 may be a key panel, a mouse or a stylus, but is not limited thereto.

The other input device 228 may be connected to the I/O subsystem 221 through an external device connection interface 248 (e.g., USB, HDMI, Bluetooth, NFC, etc.). In addition, the external device connection interface 248 may be used for an indirect connection through a network (e.g., Internet, wireless LAN, etc).

The I/O subsystem 221 may include one or more input controllers 224 for a touch panel controller 222 and the other input devices 228.

The element of software may include an operating system/driver/network connection module 232, a communication module (or set of instructions) 234, a touch/motion module (or set of instructions) 238, a graphic module (or set of instructions) 240 and a data pattern search program (set of instructions) 246.

The operating system/driver/network connection module 232 may include various software elements and/or devices that control and manage a general system task (e.g., memory management, storage device control, power management, etc.), facilitate the communication between various hardware and software elements, and control the process of connecting to the network according to a communication standard.

The communication module 234 may also include various software elements to facilitate communication with other device through one or more external device connection interfaces 248 and process the data which the RF circuit 212 and the external device connection interface 248 receive.

The touch/motion module 238 may detect a touch with the touch panel 226 together with the touch panel controller 222 and a motion of the mouse.

The graphic module 240 may include various well known software elements for providing and displaying a graphic on a display unit (DIS).

The sensor unit 253 may include an acceleration sensor, a gyro sensor, a distance sensor, a brightness sensor and the like.

Next, the data pattern search apparatus 100 and the data pattern search program according to an exemplary embodiment of the present invention are described with reference to the drawings.

FIG. 3 illustrates time series data and segment time series data. As shown in FIG. 3, the time series data may refer to data in which observed value is recorded at regular intervals as time is lapsed.

As shown in FIG. 3, the time series data may be represented in the form of smooth curve. In order to process such time series data, the data pattern search apparatus 100 according to an exemplary embodiment of the present invention of FIG. 1 may include a data conversion unit 110 and a data extraction unit 130.

As shown in FIG. 1 and FIG. 3, the data conversion unit 110 may segment the time series data to generate segment time series data. The data conversion unit 110 may transform the time series data implemented in the form of a curve into a form of connected straight lines. The data conversion unit 110 may convert the time series data into the segment time series data through a Piecewise Linear Segmentation method.

Such segmentation method is not limited to the Piecewise Linear Segmentation method, and various segmentation methods may be applied to the present invention.

The data extraction unit 130 may extract part of the segment time series data corresponding to a query inputted through the input unit (INPUT). At this time, the query may be generated according to a point or a line according to the operation of the input unit (INPUT). Since the input unit (INPUT) of the terminal 200 was described in detail with reference to the drawings, a description thereof is omitted.

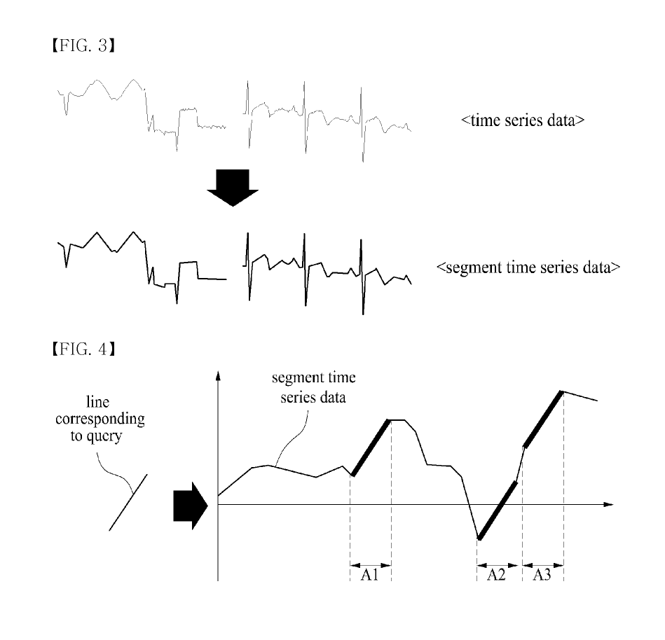

For example, as shown in FIG. 4, the data extraction unit 130 may extract part (A1, A2, A3) of the segment time series data identical with a query corresponding to line. At this time, the query may be a slope of the line.

The query may be generated as user operates the input unit (INPUT), and in this case, the data pattern search program according to an exemplary embodiment of the present invention may be executed.

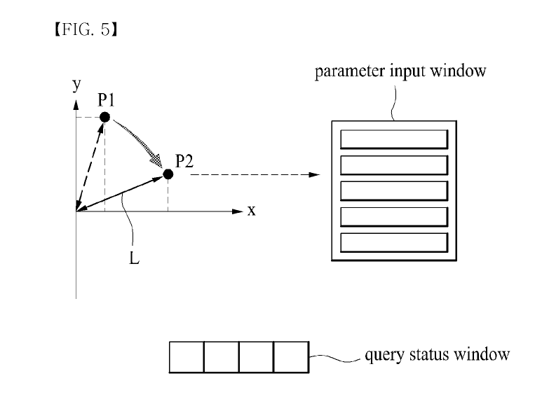

FIG. 5 is an example of an execution process of a data pattern search program according to an exemplary embodiment of the present invention.

The data pattern search program according to an exemplary embodiment of the present invention may implement a function to display a horizontal axis and a vertical axis which are perpendicular to each other through the display unit (DIS), a function to display a point or a line according to the operation of the input unit (INPUT) through the display unit (DIS) while the horizontal axis and the vertical axis are displayed, and a function to display a portion corresponding to a query according to the point or the line among time series data through the display unit (DIS).

In FIG. 5, x-axis may correspond to the horizontal axis, and y-axis may correspond to the vertical axis. The horizontal axis may refer to time, and the vertical axis may refer to a value of time series data, but are not limited thereto.

The user may operate the input unit (INPUT), and accordingly, the display unit (DIS) may display the point or the line in addition to the horizontal axis and the vertical axis. At this time, the coordinate of the point or the slope of the line may be used to set a condition for extracting a data pattern desired by the user.

The input unit (INPUT) may output an operation signal according to user's handling. For example, the operation signal may include at least one of a click signal, a touch signal, a drag signal, and a release signal, but not limited thereto and a different operation signal may be outputted according to user's handling.

The click signal may be a signal outputted from a mouse as a user operates the click of mouse. The touch signal may be a signal outputted from the touch panel when user's hand or a stylus contacts the touch panel in a short time.

The drag signal may be a signal outputted from a mouse or the touch panel when a user moves the mouse while clicking the mouse or when a user moves user's hand or a stylus while touching the touch panel with the user's hand or the stylus

The release signal may be a signal outputted from the mouse or the touch panel when user cancels the click or the touch after dragging with the input unit (INPUT).

As the example of FIG. 5, the user may click one point P1 on the plane formed by the horizontal and vertical axes with the mouse, or may touch the point with the hand or the stylus. Accordingly, a dotted line (ad hoc query) connecting origin to the one point P1 may appear in the location of the mouse pointer, the finger, or the stylus.

Next, when the mouse pointer, the finger, or the stylus moves to the point P2 as the user handles the input unit (INPUT), and then stay for a certain time, the ad hoc query of dotted line may be changed to a solid line (actual query) and a parameter input window may be created.

That is, the point P2 may be designated, such that a corresponding query may be generated by the data pattern search program of the terminal 200. The data pattern search program may automatically input the parameter of the query in accordance with the designation of the point P2 in the parameter input window.

For example, the data pattern search program may input the coordinate of the point P2 and the slope of a straight line (L) connecting the origin with the point P2 in the parameter input window. At this time, the data pattern search program may calculate the slope of the straight line connecting the origin with the point P2 by using the origin where the horizontal axis and the vertical axis intersect each other and the point P2.

At this time, the coordinate system of the terminal 200 may be different from the coordinate system of the data pattern search program according to the horizontal axis and the vertical axis. Thus, the data pattern search program may include a coordinate mapping program module for mapping those coordinate systems.

A list number of the time series data to be searched by a query may be inputted to the parameter input window according to the user's handling of the input unit (INPUT), in addition to the coordinate or the slope.

In addition, a tolerance may be inputted to the parameter input window according to the user's handling of the input unit (INPUT). The tolerance may indicate an acceptable level of an error between the query and the time series data.

Some of the parameters described above may not be used, or various parameters may be added in addition to the above mentioned parameters.

The query of such parameter may be transmitted to the data pattern search apparatus 100 from the terminal 200, and the data pattern search apparatus 100 may extract a portion corresponding to the query from the segment time series data and may provide a result of the extraction to the terminal 200.

In addition, the data pattern search program may check the current query, and may provide a query status window for deletion of the query through the display unit (DIS).

It was described in the above that the query is generated in the terminal 200. However, unlike this, the query may be generated in the data pattern search device 100. That is, the coordinate of the point P2 may be transmitted to the data pattern search apparatus 100 from the terminal 200, and the data pattern search apparatus 100 may calculate the slope of the straight line connecting the origin to the point P2.

The input unit (INPUT) such as a mouse, a touch panel or a stylus may be included in the terminal 200, but is not limited thereto and may be included in the data pattern search unit 100. In this case, the data pattern search apparatus 100 may generate a query depending on the user's handling of the input unit (INPUT).

Next, examples of various queries are described.

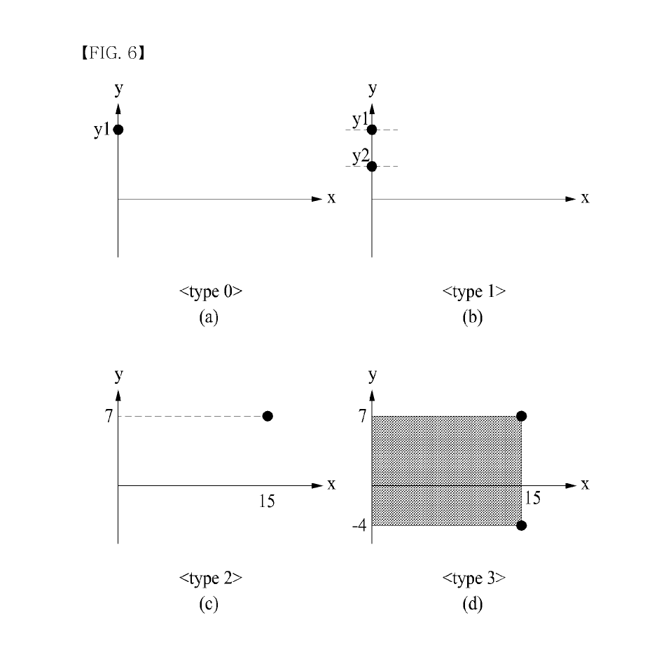

As shown in FIG. 6(a), when a user handles the input unit (INPUT) to click one point on the vertical axis in the input window or maintain a touch state for a certain time, the data pattern search program may display the coordinate of the clicked or touched location, and assign a query ID. At this time, the query ID may be type 0, and the parameters associated with the type 0 may be inputted automatically or manually to the parameter input window.

The query of type 0 may be transmitted to the data pattern search apparatus 100, and the data pattern search apparatus 100 may extract a portion corresponding to the query type 0 from the segment time series data.

That is, the data pattern search apparatus 100 may search the location of the segment time series data corresponding to a particular value y1 on the vertical axis specified by the user, and may transmit the searched result to the terminal 200.

As shown in FIG. 6(b), after the input of the type 0 for one point y1 according to the user's handling of the input unit (INPUT) is finished, when a user clicks another point on the vertical axis, or touches another point and maintains a touch state, the data pattern search program may display the coordinates (0, y1) and (0, y2) of two points, and assign the query ID to type 1.

Accordingly, the data pattern search apparatus 100 may search the location in the segment time series data where a value of particular range (from y2 to y1) specified by the user is indicated.

As shown in FIG. 6(c), after the click or the touch for the one point (e.g., y=7) on the vertical axis according to the user's handling of the input unit (INPUT) is completed, when a drag parallel with the horizontal axis and a release in a particular location (15, 7) are achieved, the data pattern search program may display the coordinates (0, 7) and (15, 7) of two points, and assign the query ID to type 2.

Accordingly, the data pattern search apparatus 100 may extract a portion that maintains a particular value (y=7) during 15 seconds which are a time specified by a user among segment time series data.

As shown in FIG. 6(d), after the type 1 is inputted according to the user's handling of the input unit (INPUT) and the click or the touch for a second point (e.g., y=−4) on the vertical axis is completed, a drag parallel with the horizontal axis and a release in a particular location (x=15) may be achieved. Accordingly, the data pattern search program may display the coordinates (15, 7) and (15, −4) of two points, and assign the query ID to type 3.

Accordingly, the data pattern search apparatus 100 may extract a portion that maintains a range (−4<y<7) of a particular value during a specified time, i.e., 15 seconds, among the segment time series data.

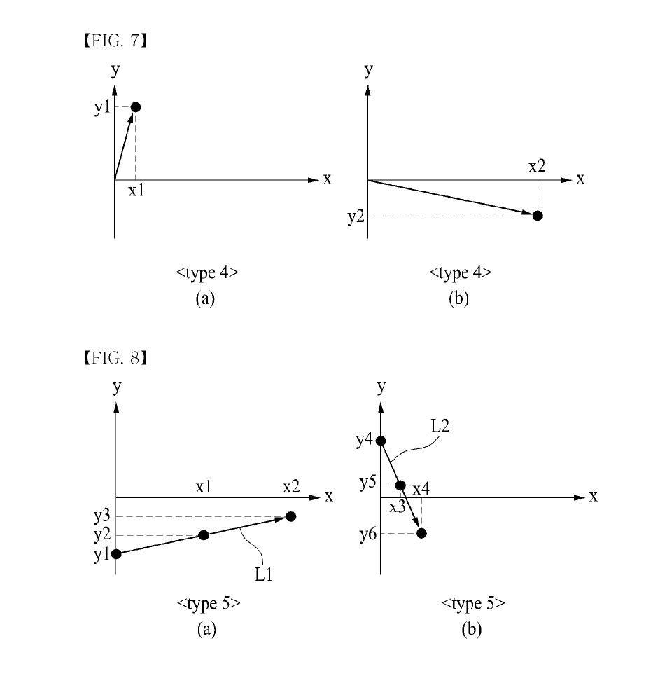

Meanwhile, as shown in FIGS. 7(a) and 7(b), after the click or the touch for the origin is completed according to the user's handling of the input unit (INPUT), a drag and release to a particular location (x1, y1) or (x2, y2) may be achieved. The data pattern search program may assign the query ID to type 4, and may calculate the slope connecting the origin to (x1, y1) or (x2, y2).

Accordingly, the data pattern search apparatus 100 may extract a portion having a calculated slope among the segment time series data. Alternatively, the data pattern search apparatus 100 may extract a portion maintaining the calculated slope from the segment time series data, during the time x1 or x2.

In addition, as shown in FIGS. 8(a) and 8(b), after the click or the touch for one point (0, y1) or (0, y4) on the vertical axis not for the origin is performed according to the user's handling of the input unit (INPUT), a drag and release to a particular location (x2, y3) or (x4, y6) may be achieved.

The data pattern search program may assign the query ID to type 5, calculate the slope of line L1 or L2, and may calculate the intermediate value y2 of y1 and y3, or may calculate the intermediate value y5 of y4 and y6.

Accordingly, the data pattern search apparatus 100 may extract a portion having a calculated slope while having a data value of y2 or y5 among the segment time series data.

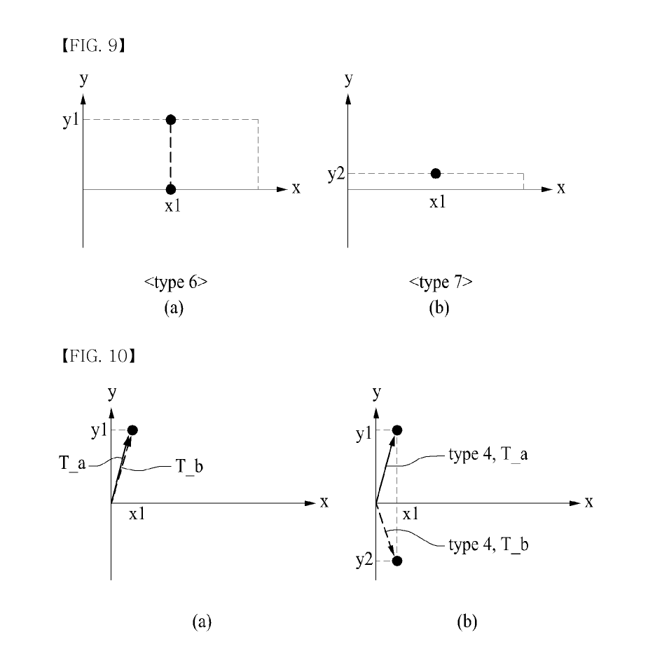

As shown in FIGS. 9(a) and 9(b), after the click or the touch for one point (x1, 0) on the horizontal axis is performed according to the user's handling of the input unit (INPUT), a drag parallel with the vertical axis and a release in a particular location (x1, y1) or (x2, y2) may be achieved.

Thereafter, when a user inputs a maximum or a minimum value to the parameter input window, the data pattern search program according to an exemplary embodiment of the present invention may assign type 6 (maximum value search query) and type 7 (a minimum value search query). Accordingly, the data pattern search apparatus 100 may extract a portion below y1 or above y2 among the segment time series data.

The data pattern search program according to an exemplary embodiment of the present invention may implement a function to display the coordinate of each specified point which is clicked or touched according to the user's handling of the input unit (INPUT) in order to set a query of type 0 to type 7 through the display unit (DIS).

As described above through the FIGS. 6 to 9, the data pattern search program according to an exemplary embodiment of the present invention may implement a function to generate the coordinate of point or the coordinate of the end point of line when the origin is defined as the intersection of the horizontal axis and the vertical axis, and a function to generate automatically the parameter of query through at least one of the coordinate of the point and the coordinate of the end point of line.

Hereinafter, a complex query is described with reference to the drawings.

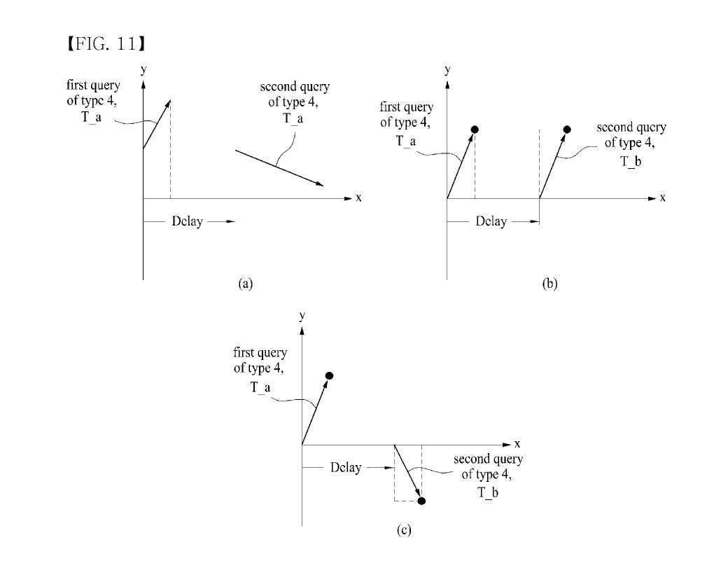

As shown in FIG. 10(a), different time series data T_a, T_b may be searched through the query of type 4 which is set according to the handling of the input unit (INPUT). The name of time series data may be inputted to the parameter input window of FIG. 5.

In addition, as shown in FIG. 10(b), different time series data T_a, T_b may be searched through the query of type 4 which is set according to the handling of the input unit (INPUT).

That is, the query of type 4 having a positive slope may be used to search the time series data T_a, and the query of type 4 having a negative slope may be used to search the time series data T_b.

Since the query setting of FIG. 10(b) was described above in detail with reference to FIG. 7, a description thereof is omitted.

Meanwhile, as shown in FIG. 11(a), the two queries of type 4 may be used to search one time series data. At this time, a time delay may be set between the two queries of type 4.

The horizontal axis distance between the two queries of type 4 set according to the handling of the input unit (INPUT) may be calculated automatically such that the time delay may be inputted to the parameter input window automatically or may be inputted to the parameter input window by a user.

Accordingly, the data pattern search apparatus 100 may extract the data having a negative slope (second query of type 4) from the time series data T_a after a preset time delay from the data having a positive slope (first query of type 4).

As shown in FIGS. 11(b) and 11(c), two queries of type 4 may be used to search different time series data T_a and T_b. At this time, a time delay may be set between two queries of type 4.

Accordingly, the data pattern search apparatus 100 may extract a portion of the time series data T_b corresponding to the second query of type 4 from the time series data T_b after a preset time delay from a portion of the time series data T_a corresponding to the first query of type 4

Meanwhile, as shown in FIG. 12, a plurality of queries may be used to search the time series data T_a continuously without a time delay. Accordingly, the data pattern search apparatus 100 may extract data formed by connecting sequentially a portion corresponding to query 1, a portion corresponding to query 2, a portion corresponding to query 3, and a portion corresponding to query 4 from the time series data T_a.

As described above, the data pattern search program according to an exemplary embodiment of the invention may input a sequence of the pattern that may exist within one time series data T_a as a query.

As described above in FIG. 11(a), the computer program according to an exemplary embodiment of the present invention may implement a function to display another portion of the time series data which is delayed from a portion corresponding to a query (e.g., a first query) and which corresponds to an additional query (e.g., a second query) through the display unit (DIS), according to an input of the time delay information and the additional query through the input unit (INPUT).

In addition, as described above in FIG. 10(b), FIGS. 11(b) and 11(c), the computer program according to an exemplary embodiment of the present invention may implement a function to display a portion of additional time series data (T_b) which is delayed from a portion of the time series data (T_a) corresponding to a query (e.g., a first query) and which corresponds to an additional query (e.g., a second query) through the display unit (DIS), according to an input of the time delay information and the additional query through the input unit (INPUT).

As described above, a complex query may be formed by combining the basic queries described above through FIGS. 6 to 9. That is, as shown in FIG. 10 to FIG. 12, the query may be one of n (n is a natural number greater than 2) basic queries, and the additional query may be one of n (n is a natural number greater than 2) basic queries.

At this time, the query may be the same as the additional query. For example, the additional query which is the same as the query may be delayed from the query according to delay information.

Meanwhile, as described above, since the time series data are segmented, the time series data displayed through the display unit (DIS) may be formed of a plurality of straight lines. The portion corresponding to the query may be a point located in the plurality of straight lines or may be some straight lines of the plurality of straight lines.

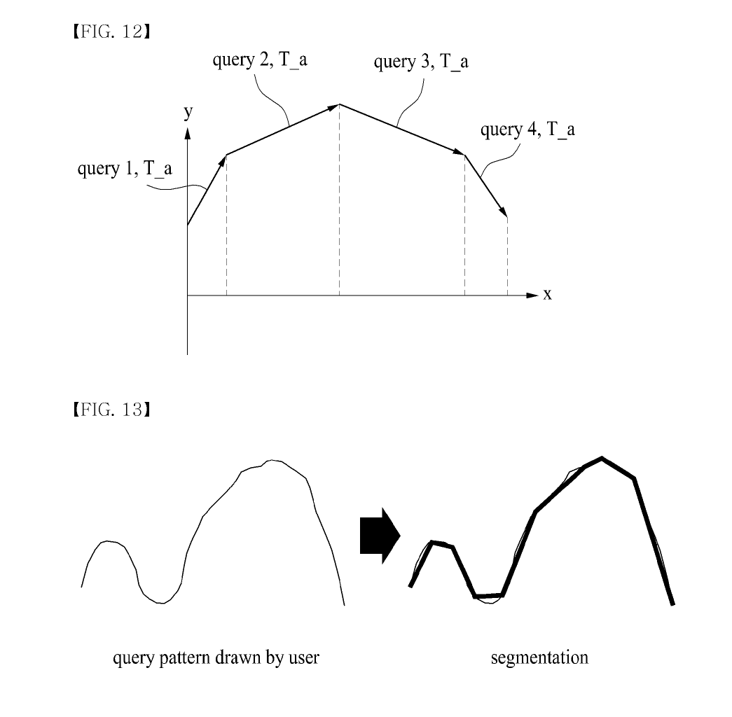

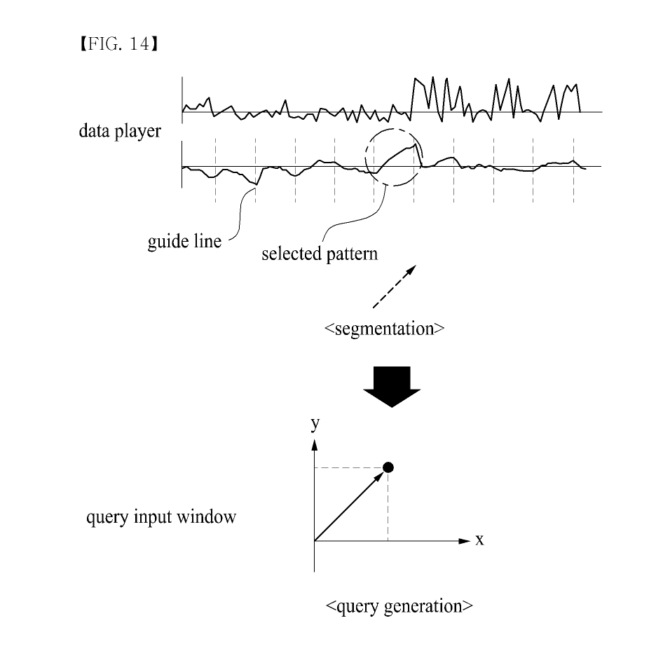

Meanwhile, as shown in FIG. 13, when a user handles the input unit (INPUT) to input a query pattern of curve form, the data pattern search program according to an exemplary embodiment of the present invention may perform segmentation for the query pattern of curve form to be changed into a sequence form of the segments.

To this end, the data pattern search program according to an exemplary embodiment of the present invention may change the query pattern of curve into a sequence type of segments through a piecewise linear segmentation method.

That is, the data pattern search program according to an exemplary embodiment of the present invention may implement a function to change the curve query pattern displayed on the display unit (DIS) according to the operation of the input unit (INPUT) into segment, and a function to display a portion of the time series data corresponding to the query of each segment through the display unit (DIS).

The data pattern search program according to an exemplary embodiment of the present invention may derive the location corresponding to a boundary of each segment. The boundary of each segment may be set through the variation of slope of the segment.

Accordingly, since the slope of segment and the coordinates of both end points of segment may be derived, a query may be generated through the slope of segment or the coordinates of both end points of segment.

Since the curve query pattern may be changed into a sequence form of segments as described above, the data pattern searching unit 100 may extract the data which connect sequentially a portion corresponding to a plurality of queries from the time series data T_a, as mentioned above in FIG. 12.

Meanwhile, as shown in FIG. 14, when the time series data are displayed on the display unit (DIS), a section displaying a pattern desired by a user according to the user's handling of the input unit (INPUT) may be selected.

Accordingly, the data pattern search program according to an exemplary embodiment of the present invention may derive the location of the time series data corresponding to the selected section through the above described coordinate mapping program module.

The data pattern search program according to an exemplary embodiment of the present invention may perform segmentation for the time series data corresponding to the selected section to generate one or more segments, and may generate a corresponding query through the slope of the segment and the coordinate of the segment end point.

Accordingly, the data pattern search apparatus 100 may search a portion corresponding to the query among time series data. At this time, the time series data searched through the query may be the time series data including the section displaying the selected pattern or may be different from the time series data including the section displaying the selected pattern.

Thus, the data pattern search program of the present invention may implement a function to automatically generate a query corresponding to part of time series data specified according to the operation of the input unit (INPUT).

Meanwhile, as shown in FIG. 14, the computer program according to an exemplary embodiment of the present invention may implement a function to display a guide line representing each segment of the time series data and a function to match the segment to the query.

That is, the computer program according to an exemplary embodiment of the present invention may change the time series data into the segment time series data, and may display the boundary of each segment that configures the segment time series data like a gradation.

The data pattern search program according to an exemplary embodiment of the present invention may be recorded in a recording medium. That is, the recording medium according to an exemplary embodiment of the present invention may read a program to execute a function to display a horizontal axis and a vertical axis which perpendicularly intersect each other through the display unit (DIS), a function to display a point or a line according to the operation of the input unit (INPUT) through the display unit (DIS) while the horizontal axis and the vertical axis are displayed, and a function to display a portion corresponding to a query according to a point or a line among the time series data through the display unit (DIS), by a computer.

Through an apparatus, a recording medium, a terminal, and a computer program for searching a data pattern according to an embodiment of the present invention, a user may handle the input unit to generate a query through a point or a line such that a general user as well as an expert may be able to search a pattern of time series data.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A computer program configured to execute functions of:
displaying a horizontal axis and a vertical axis which intersect each other perpendicularly through a display unit;
displaying a point or a line according to operation of an input unit through the display unit in a state in which the horizontal axis and the vertical axis are displayed; and
displaying a part corresponding to a query according to the point or the line among time series data through the display unit.

2. The computer program of claim 1, wherein the time series data, which are displayed through the display unit, comprise a plurality of straight lines, and the part corresponding to the query is a point located in the plurality of straight lines or some of the plurality of straight lines.

3. The computer program of claim 1, executing functions of:
generating a coordinate of the point or a coordinate of an end point of the line when a point of intersection of the horizontal axis and the vertical axis is defined as origin; and
automatically generating a parameter of the query through at least one of the coordinate of the point and the coordinate of the end point of the line.

4. The computer program of claim 1, executing a function of displaying another portion of the time series data which is delayed according to time delay information from a portion corresponding to a query and which corresponds to an additional query through the display unit, according to an input of the time delay information and the additional query through the input unit.

5. The computer program of claim 1, executing a function of displaying a portion of additional time series data which is delayed according to time delay information from a portion of the time series data corresponding to the query and which corresponds to an additional query through the display unit, according to an input of the time delay information and the additional query through the input unit.

6. The computer program of claim 4, wherein the query is one of n (n is a natural number greater than 2) basic queries, and the additional query is one of the n (n is a natural number greater than 2) basic queries.

7. The computer program of claim 1, executing functions of:
changing a curve query pattern displayed on the display unit into a segment according to an operation of the input unit; and
displaying a portion of the time series data corresponding to a query of each of the segment through the display unit.

8. The computer program of claim 1, executing a function of automatically generating a query corresponding to a part of the time series data specified according to operation of the input unit.

9. The computer program of claim 8, executing functions of:
displaying a guide line to represent each segment of the time series data; and
matching the segment to the query.

10. A terminal comprising:
a display unit;
a central processing unit (CPU) configured to execute a set of instructions contained in a data pattern search program stored in a memory; and
an input unit configured to output an operation signal according to user's handling,
wherein the data pattern search program performs functions of:
displaying a horizontal axis and a vertical axis which intersect each other perpendicularly through the display unit;
displaying a point or a line according to operation of the input unit through the display unit in a state in which the horizontal axis and the vertical axis are displayed; and
displaying a part corresponding to a query according to the point or the line among time series data through the display unit.

11. The terminal of claim 10, wherein the time series data, which are displayed through the display unit, comprise a plurality of straight lines, and the part corresponding to the query is a point located in the plurality of straight lines or some of the plurality of straight lines.

12. The terminal of claim 10, wherein the data pattern search program performs functions of:
generating a coordinate of the point or a coordinate of an end point of the line when a point of intersection of the horizontal axis and the vertical axis is defined as origin; and
automatically generating a parameter of the query through at least one of the coordinate of the point and the coordinate of the end point of the line.

13. The terminal of claim 10, wherein the data pattern search program performs a function of displaying another portion of the time series data which is delayed according to time delay information from a portion corresponding to a query and which corresponds to an additional query through the display unit, according to an input of the time delay information and the additional query through the input unit.

14. The terminal of claim 10, wherein the data pattern search program performs a function of displaying a portion of additional time series data which is delayed according to time delay information from a portion of the time series data corresponding to the query and which corresponds to an additional query through the display unit, according to an input of the time delay information and the additional query through the input unit.

15. The terminal of claim 13, wherein the query is one of n (n is a natural number greater than 2) basic queries, and the additional query is one of the n (n is a natural number greater than 2) basic queries.

16. The terminal of claim 14, wherein the query is one of n (n is a natural number greater than 2) basic queries, and the additional query is one of the n (n is a natural number greater than 2) basic queries.

17. The terminal of claim 10, wherein the data pattern search program performs functions of:
changing a curve query pattern displayed on the display unit into a segment according to an operation of the input unit; and
displaying a portion of the time series data corresponding to a query of each of the segment through the display unit.

18. The terminal of claim 10, wherein the data pattern search program performs a function of automatically generating a query corresponding to a part of the time series data specified according to operation of the input unit.

19. The terminal of claim 18, wherein the data pattern search program performs functions of:
displaying a guide line to represent each segment of the time series data; and
matching the segment to the query.

20. A data pattern search apparatus comprising:
a data conversion unit configured to perform segmentation for time series data to generate segment time series data; and
a data extraction unit configured to extract part of the segment time series data corresponding to a query inputted through an input unit,
wherein the query is generated according to a point or a line according to operation of the input unit.

21. The computer program of claim 5, wherein the query is one of n (n is a natural number greater than 2) basic queries, and the additional query is one of the n (n is a natural number greater than 2) basic queries.
